(19) United States
(12) Patent Application Publication
(10) Pub. No.: US 2022/0414944 A1
(43) Pub. Date: Dec. 29, 2022

(54) DISPLAY TERMINAL DEVICE

(71) Applicant: Sony Group Corporation, Tokyo (JP)

(72) Inventors: Kenji TOKUTAKE, Tokyo (JP); Masaaki TSUKIOKA, Tokyo (JP)

(73) Assignee: Sony Group Corporation, Tokyo (KR)

(21) Appl. No.: 17/778,003

(22) PCT Filed: Nov. 28, 2019
(86) PCT No.: PCT/JP2019/046514

§ 371 Date: May 19, 2022

(51) Int. Cl. G06T 11/00; G06T 7/70; H04N 5/265

(52) U.S. Cl. CPC G06T 11/00; G06T 7/70; H04N 5/265

(57) ABSTRACT

In a display terminal device, a CPU determines an arrangement position of a virtual object in real space by software processing and outputs a first image, which is an image of the virtual object, and information indicating the arrangement position. An imaging unit captures a second image, which is an image of the real space. A synthesizer generates a synthetic image by combining the first image and the second image by hardware processing based on the arrangement position. A display is directly connected to the synthesizer and displays the synthetic image.

### FIELD

The present disclosure relates to a display terminal device.

### BACKGROUND

Display terminal devices have been developed for achieving service using augmented reality (AR) technology. Examples of the display terminal devices include a head mounted display (HMD). The HMD includes, for example, an optical see-through type HMD and a video see-through type HMD.

In the optical see-through type HMD, for example, a virtual image optical system using a half mirror or a transparent light guide plate is held in front of the eyes of a user. An image is displayed inside the virtual image optical system. Therefore, the user wearing the optical see-through type HMD can view a landscape around the user even while viewing the image displayed inside the virtual image optical system. Thus, the optical see-through type HMD adopting the AR technology can superimpose an image (hereinafter, may be referred to as “virtual object image”) of a virtual object (hereinafter, may be referred to as “virtual object”) in various modes such as text, an icon, and animation on an optical image of an object existing in real space in accordance with the position and posture of the optical see-through type HMD.

In contrast, the video see-through type HMD is worn by a user so as to cover the eyes of the user, and the display of the video see-through type HMD is held in front of the eyes of the user. Furthermore, the video see-through type HMD includes a camera module for capturing an image of a landscape in front of the user, and the image of the landscape captured by the camera module is displayed on the display. Therefore, although the user wearing the video see-through type HMD has difficulty in directly viewing the landscape in front of the user, the user can see the landscape in front of the user with the image on the display. Furthermore, the video see-through type HMD adopting the AR technology can use the image of the landscape in front of the user as an image of the background in real space (hereinafter, may be referred to as “background image”) to superimpose the virtual object image on the background image in accordance with the position and posture of the video see-through type HMD. Hereinafter, an image obtained by superimposing a virtual object image on a background image may be referred to as a “synthetic image”.

### CITATION LIST

### Patent Literature

Patent Literature 1: JP 2018-517444 A

Patent Literature 2: JP 2018-182511 A

### SUMMARY

### Technical Problem

Here, in the AR technology used in the video see-through type HMD, superimposition of a virtual object image on a background image is performed by software processing, which relatively requires time, including analysis of the background image and the like. Therefore, the delay that occurs between the time point when the background image has been captured and the time point when the synthetic image including the background image is displayed is increased in the video see-through type HMD. Furthermore, the background image changes at any time along with the movement of the video see-through type HMD.

Thus, when the orientation of the face of a user wearing the video see-through type HMD is changed, the speed of update of the background image on the display sometimes fails to follow the speed of change in the orientation of the face of the user. Thus, for example, as illustrated in FIG. 1, when the orientation of the face of the user wearing the video see-through type HMD changes from an orientation D1 to an orientation D2, the background image BI captured at the time of the orientation D1 is sometimes displayed on the display even at the time point of the orientation D2. Therefore, the background image BI displayed on the display at the time point when the orientation of the face of the user reaches the orientation D2 is different from an actual landscape FV in front of the user, so that a feeling of strangeness of the user is increased.

Furthermore, in the background image and the virtual object image included in the synthetic image, the virtual object image is superimposed on the background image while the background image changes along with the movement of the video see-through type HMD as described above. Therefore, when the video see-through type HMD moves, the user has difficulty in recognizing the delay between the time point when the background image has been captured and the time point when the virtual object image to be superimposed on the background image is displayed or updated while the user easily recognizes the delay in updating the background image. That is, the user is insensitive to the display delay of a virtual object image while being sensitive to the update delay of a background image. Thus, increased update delay of the background image increases a feeling of strangeness of the user.

Therefore, the present disclosure proposes a technique capable of reducing a feeling of strangeness of a user wearing a display terminal device such as the video see-through type HMD adopting the AR technology.

### Solution to Problem

According to the present disclosure, a display terminal device includes a CPU, an imaging unit, a synthesizer and a display. The CPU determines an arrangement position of a virtual object in real space by software processing and outputs a first image, which is an image of the virtual object, and information indicating the arrangement position. The imaging unit captures a second image, which is an image of the real space. The synthesizer generates a synthetic image by combining the first image and the second image by hardware processing based on the arrangement position. The display is directly connected to the synthesizer and displays the synthetic image.

### BRIEF DESCRIPTION OF DRAWINGS

FIG. 1 illustrates a problem of the present disclosure.

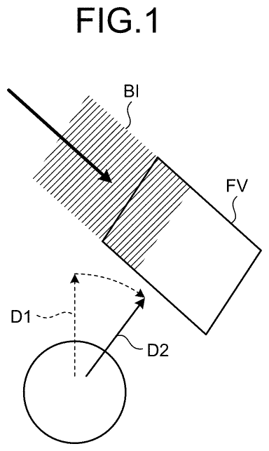

FIG. 2 illustrates a configuration example of a display terminal device according to an embodiment of the present disclosure.

FIG. 3 illustrates one example of a processing procedure in the display terminal device according to the embodiment of the present disclosure.

FIG. 4 illustrates image synthesizing processing according to the embodiment of the present disclosure.

FIG. 5 illustrates image synthesizing processing according to the embodiment of the present disclosure.

FIG. 6 illustrates an effect of a technique of the present disclosure.

### DESCRIPTION OF EMBODIMENTS

An embodiment of the present disclosure will be described below with reference to the drawings. Note that, in the following embodiment, the same reference signs are attached to the same parts or the same processing to omit duplicate description.

Furthermore, the technique of the present disclosure will be described in the following item order.
<Configuration of Display Terminal Device>
<Processing Procedure in Display Terminal Device>
<Image Synthesizing Processing>
<Effects of Disclosed Technique>

### <Configuration of Display Terminal Device>

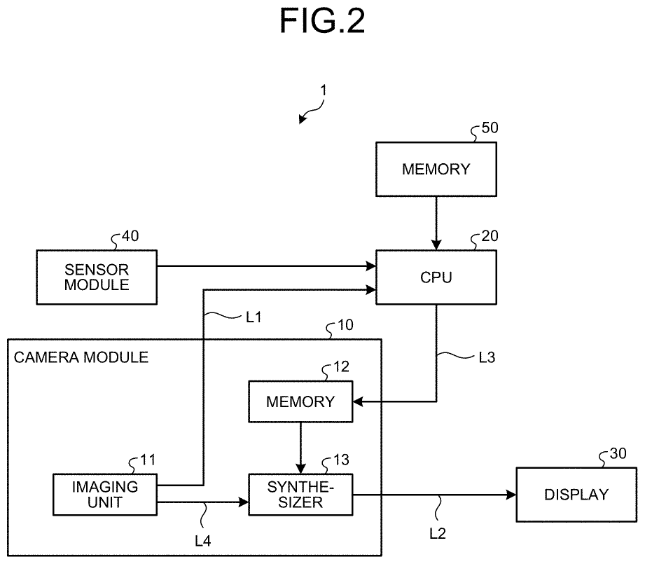

FIG. 2 illustrates a configuration example of a display terminal device according to the embodiment of the present disclosure. In FIG. 2, a display terminal device 1 includes a camera module 10, a central processing unit (CPU) 20, a display 30, a sensor module 40, and a memory 50. The camera module 10 includes an imaging unit 11, a memory 12, and a synthesizer 13. The display terminal device 1 is worn by a user of the display terminal device 1 so as to cover the eyes of the user. Examples of the display terminal device 1 include a video see-through type HMD and a smart device such as a smartphone and a tablet terminal. When the display terminal device 1 is a smart device, the smart device is worn by a user of the smart device with a head-mounted instrument for the smart device so as to cover the eyes of the user.

The camera module 10 includes lines L1, L2, L3, and L4. The imaging unit 11 is connected to the CPU 20 via the line L1 while connected to the synthesizer 13 via the line L4. The memory 12 is connected to the CPU 20 via the line L3. The synthesizer 13 is connected to the display 30 via the line L2.

The imaging unit 11 includes a lens unit and an image sensor. The imaging unit 11 captures an image of a landscape in front of the user wearing the display terminal device 1 such that the eyes of the user are covered by the display terminal device 1 as a background image. The imaging unit 11 outputs the captured background image to the synthesizer 13 and the CPU 20. The imaging unit 11 captures background images at a predetermined frame rate. The imaging unit 11 outputs the same background image captured at the same time point to the synthesizer 13 via the line L4 on the one hand, and outputs the same background image to the CPU 20 via the line L1 on the other hand. That is, the camera module 10 includes the line L1 through which a background image captured by the camera module 10 is output from the camera module 10 to the CPU 20.

The sensor module 40 detects an acceleration and an angular velocity of the display terminal device 1 in order to detect a change in the position and the posture of the display terminal device 1, and outputs information indicating the detected acceleration and angular velocity (hereinafter, may be referred to as “sensor information”) to the CPU 20. Examples of the sensor module 40 include an inertial measurement unit (IMU).

The CPU 20 performs simultaneous localization and mapping (SLAM) based on the background image and the sensor information at a predetermined cycle. That is, the CPU 20 generates an environment map and a pose graph in the SLAM based on the background image and the sensor information. The CPU 20 recognizes real space in which the display terminal device 1 exists with the environment map. The CPU 20 recognizes the position and posture of the display terminal device 1 in the recognized real space with the pose graph. Furthermore, the CPU 20 determines the arrangement position of a virtual object in the real space, that is, the arrangement position of a virtual object image in the background image (hereinafter, may be referred to as “virtual object arrangement position”) based on the generated environment map and pose graph. The CPU 20 outputs information indicating the determined virtual object arrangement position (hereinafter, may be referred to as “arrangement position information”) to the memory 12 in association with the virtual object image. The CPU 20 outputs the virtual object image and the arrangement position information to the memory 12 via the line L3.

The memory 50 stores an application executed by the CPU 20 and data used by the CPU 20. For example, the memory 50 stores data on a virtual object (e.g., data for reproducing shape and color of virtual object). The CPU 20 generates a virtual object image by using the data on a virtual object stored in the memory 50.

The memory 12 stores the virtual object image and the arrangement position information input from the CPU 20 at a predetermined cycle for predetermined time.

The synthesizer 13 generates a synthetic image by superimposing the virtual object image on the background image based on the latest virtual object image and arrangement position information among virtual object images and pieces of arrangement position information stored in the memory 12. That is, the synthesizer 13 generates the synthetic image by superimposing the latest virtual object image on the latest background image input from the imaging unit 11 at the position indicated by the arrangement position information. The synthesizer 13 outputs the generated synthetic image to the display 30 via the line L2. That is, the camera module 10 includes the line L2 through which a synthetic image generated by the camera module 10 is output from the camera module 10 to the display 30.

The synthesizer 13 is implemented as hardware, and implemented by, for example, an electronic circuit created by wired logic. That is, the synthesizer 13 generates a synthetic image by combining a background image and a virtual object image by hardware processing. Furthermore, the synthesizer 13 and the display 30 are directly connected to each other by hardware via the line L2.

The display 30 displays a synthetic image input from the synthesizer 13. This causes the synthetic image obtained by superimposing the virtual object image on the background image to be displayed in front of the eyes of the user wearing the display terminal device 1.

Here, both the camera module 10 and the display 30 are compliant with the same interface standard, for example, the mobile industry processor interface (MIPI) standard. When both the camera module 10 and the display 30 are compliant with the MIPI standard, a background image captured by the imaging unit 11 is serially transmitted to the synthesizer 13 through a camera serial interface (CSI) in accordance with the MIPI standard. A synthetic image generated by the synthesizer 13 is serially transmitted to the display 30 through a display serial interface (DSI) in accordance with the MIPI standard.

### <Processing Procedure in Display Terminal Device>

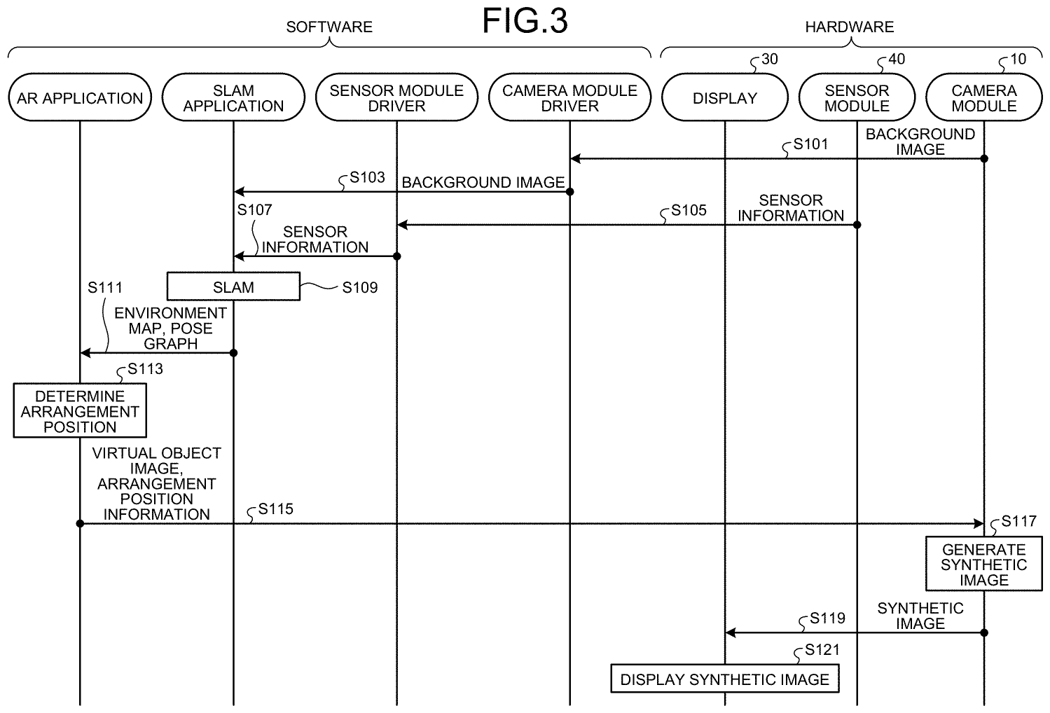

FIG. 3 illustrates one example of a processing procedure in the display terminal device according to the embodiment of the present disclosure.

A camera module driver, a sensor module driver, a SLAM application, and an AR application in FIG. 3 are software stored in the memory 50 and executed by the CPU 20. In contrast, the camera module 10, the sensor module 40, and the display 30 are hardware. The camera module driver in FIG. 3 is a driver for the camera module 10. The sensor module driver in FIG. 3 is a driver for the sensor module 40.

In FIG. 3, in Step S101, the camera module 10 outputs a background image to the CPU 20. In Step S103, the background image input to the CPU 20 is passed to the SLAM application via the camera module driver.

Furthermore, in parallel with the processing in Step S101, the sensor module 40 outputs sensor information to the CPU 20 in Step S105. The sensor information input to the CPU 20 is passed to the SLAM application via the sensor module driver in Step S107.

Then, in Step S109, the SLAM application performs SLAM based on the background image and the sensor information to generate an environment map and a pose graph in the SLAM.

Then, in Step S111, the SLAM application passes the environment map and the pose graph generated in Step S109 to the AR application.

Then, in Step S113, the AR application determines the virtual object arrangement position based on the environment map and the pose graph.

Then, in Step S115, the AR application outputs the virtual object image and the arrangement position information to the camera module 10. The virtual object image and the arrangement position information input to the camera module 10 are associated with each other, and stored in the memory 12.

In Step S117, the camera module 10 generates a synthetic image by superimposing the virtual object image on the background image based on the latest virtual object image and arrangement position information among virtual object images and pieces of arrangement position information stored in the memory 12.

Then, in Step S119, the camera module 10 outputs the synthetic image generated in Step S117 to the display 30.

Then, in Step S121, the display 30 displays the synthetic image input in Step S119.

### <Image Synthesizing Processing>

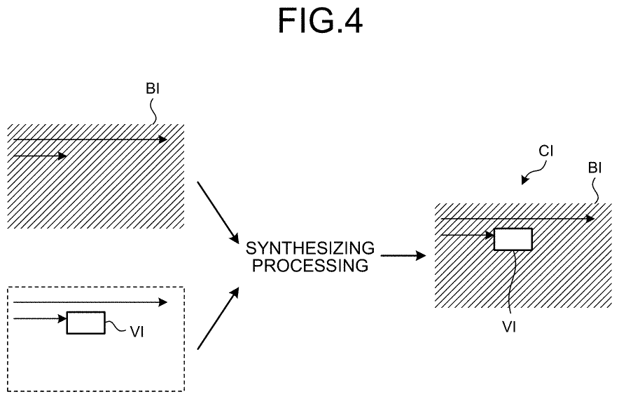

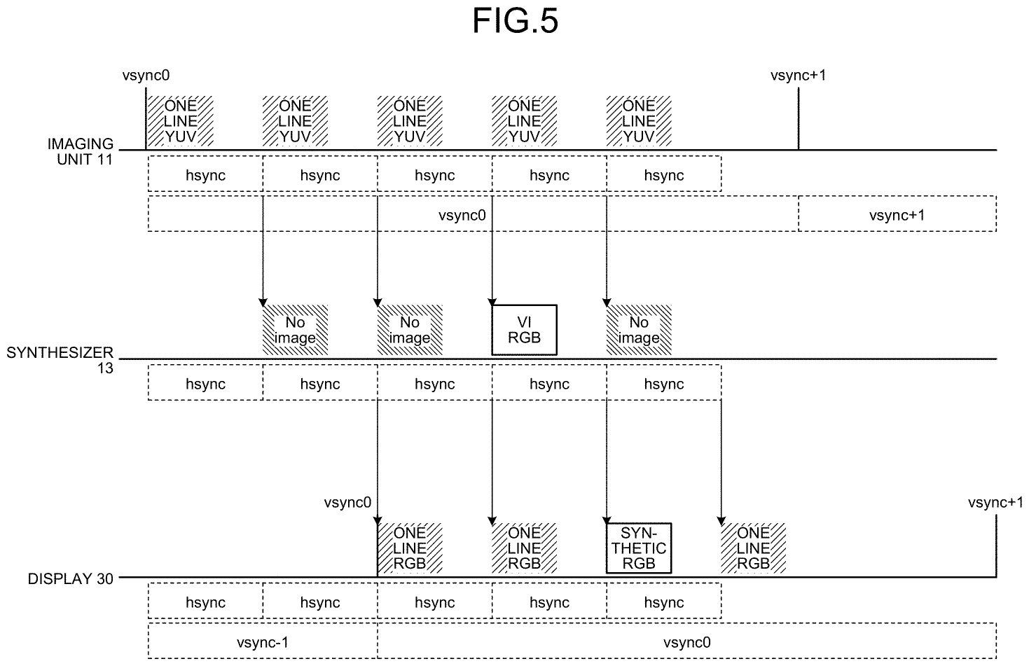

FIGS. 4 and 5 illustrate image synthesizing processing according to the embodiment of the present disclosure.

As illustrated in FIG. 4, the synthesizer 13 generates a synthetic image CI by superimposing a virtual object image VI on a background image BI for each line in the horizontal direction (row direction) of the background image BI of each frame.

For example, the imaging unit 11, the synthesizer 13, and the display 30 operate as illustrated in FIG. 5 based on a vertical synchronization signal vsync and a horizontal synchronization signal hsync. In FIG. 5, “vsync+1” indicates a vertical synchronization signal input next to a vertical synchronization signal vsync0, and “vsync−1” indicates a vertical synchronization signal input one signal before the vertical synchronization signal vsync0. Furthermore, FIG. 5 illustrates, as one example, a case where five horizontal synchronization signals hsync are input while one vertical synchronization signal vsync is input.

In FIG. 5, the imaging unit 11 outputs YUV data (one line YUV) for each line of the background image BI to the synthesizer 13 in accordance with the horizontal synchronization signal hsync.

The synthesizer 13 converts the YUV data input from the imaging unit 11 into RGB data. Furthermore, the synthesizer 13 superimposes the RGB data (VI RGB) of the virtual object image VI on the RGB data of the background image BI for each line in accordance with the horizontal synchronization signal hsync and the arrangement position information. Thus, in the line where the virtual object image VI exists, the RGB data (synthetic RGB) of the synthetic image is output from the synthesizer 13 to the display 30 and displayed. In the line where the virtual object image VI does not exist (no image), the RGB data (one line RGB) of the background image BI is output as it is from the synthesizer 13 to the display 30 and displayed.

The embodiment of the technique of the present disclosure has been described above.

Note that FIG. 2 illustrates a configuration of the display terminal device 1. In the configuration, the camera module 10 includes the memory 12 and the synthesizer 13. The display terminal device 1, however, can also adopt a configuration in which one or both of the memory 12 and the synthesizer 13 are provided outside the camera module 10.

### <Effects of Disclosed Technique>

As described above, the display terminal device according to the present disclosure (display terminal device 1 according to embodiment) includes the CPU (CPU 20 according to embodiment), the imaging unit (imaging unit 11 according to embodiment), the synthesizer (synthesizer 13 according to embodiment), and the display (display 30 according to embodiment). The CPU determines the arrangement position of a virtual object in real space (virtual object arrangement position according to embodiment) by software processing, and outputs a first image (virtual object image according to embodiment), which is an image of the virtual object, and information indicating the arrangement position (arrangement position information according to embodiment). The imaging unit captures a second image (background image according to embodiment), which is an image of the real space. The synthesizer generates a synthetic image by combining the first image and the second image by hardware processing based on the arrangement position. The display is directly connected to the synthesizer, and displays the synthetic image.

For example, the camera module including the imaging unit and the synthesizer includes a first line (line L1 according to embodiment) and a second line (line L2 according to embodiment). The first image is output from the camera module to the CPU through the first line. The synthetic image is output from the camera module to the display through the second line.

Furthermore, for example, the synthesizer combines the first image and the second image for each line in the horizontal direction of the second image.

Furthermore, for example, both the camera module and the display are compliant with the MIPI standard.

Furthermore, for example, the CPU generates an environment map and a pose graph by performing SLAM based on the second image, and determines the arrangement position based on the environment map and the pose graph.

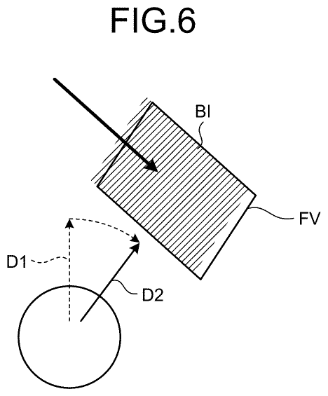

According to the above-described configuration, a background image captured by the imaging unit is output to the display directly connected to the synthesizer without being subjected to software processing performed by the CPU, so that the background image is immediately displayed on the display after being captured by the imaging unit. Therefore, it is possible to reduce the delay that occurs between the time point when the background image has been captured and the time point when the synthetic image including the background image is displayed. Therefore, when the orientation of the face of a user wearing the display terminal device according to the present disclosure is changed, the background image on the display can be updated so as to follow the change in the orientation of the face of the user. Thus, for example, as illustrated in FIG. 6, when the orientation of the face of the user wearing the display terminal device according to the present disclosure changes from an orientation Dl to an orientation D2, the background image BI captured at the time when the orientation of the face of the user reaches the orientation D2 is displayed on the display at the time of the orientation D2. Therefore, the difference between the background image BI displayed on the display at the time point when the orientation of the face of the user reaches the orientation D2 and an actual landscape FV in front of the user is reduced to a degree in which the user has difficulty in recognizing the difference. Thus, according to the above-described configuration, a feeling of strangeness of a user wearing the display terminal device can be reduced.

Note that the effects set forth in the specification are merely examples and not limitations. Other effects may be exhibited.

Furthermore, the technique of the present disclosure can also adopt the configurations as follows.
(1) A display terminal device comprising:
   a CPU that determines an arrangement position of a virtual object in real space by software processing and outputs a first image, which is an image of the virtual object, and information indicating the arrangement position;
   an imaging unit that captures a second image, which is an image of the real space;
   a synthesizer that generates a synthetic image by combining the first image and the second image by hardware processing based on the arrangement position; and
   a display that is directly connected to the synthesizer and displays the synthetic image.
(2) The display terminal device according to (1), further comprising
   a camera module that includes the imaging unit and the synthesizer,
   wherein the camera module includes: a first line through which the first image is output from the camera module to the CPU; and a second line through which the synthetic image is output from the camera module to the display.
(3) The display terminal device according to (1) or (2), wherein the synthesizer combines the first image and the second image for each line in a horizontal direction of the second image.
(4) The display terminal device according to (2), wherein both the camera module and the display are compliant with an MIPI standard.
(5) The display terminal device according to any one of (1) to (4),
   wherein the CPU generates an environment map and a pose graph by performing SLAM based on the second image, and determines the arrangement position based on the environment map and the pose graph.

### REFERENCE SIGNS LIST

1 Display Terminal Device

10 Camera Module

11 Imaging Unit

13 Synthesizer

20 CPU

30 Display

40 Sensor Module

1. A display terminal device comprising:
a CPU that determines an arrangement position of a virtual object in real space by software processing and outputs a first image, which is an image of the virtual object, and information indicating the arrangement position;
an imaging unit that captures a second image, which is an image of the real space;
a synthesizer that generates a synthetic image by combining the first image and the second image by hardware processing based on the arrangement position; and
a display that is directly connected to the synthesizer and displays the synthetic image.

2. The display terminal device according to claim 1, further comprising
a camera module that includes the imaging unit and the synthesizer,
wherein the camera module includes: a first line through which the first image is output from the camera module to the CPU; and a second line through which the synthetic image is output from the camera module to the display.

3. The display terminal device according to claim 1,
wherein the synthesizer combines the first image and the second image for each line in a horizontal direction of the second image.

4. The display terminal device according to claim 2,
wherein both the camera module and the display are compliant with an MIPI standard.

5. The display terminal device according to claim 1,
wherein the CPU generates an environment map and a pose graph by performing SLAM based on the second image, and determines the arrangement position based on the environment map and the pose graph.
